(19) United States
(12) Patent Application Publication
(10) Pub. No.: US 2018/0191849 A1
(43) Pub. Date: Jul. 5, 2018

(54) METHOD AND SYSTEM FOR TRACKING RESIDENTIAL INTERNET ACTIVITIES

(71) Applicant: BelleFox, Inc., Santa Clara, CA (US)

(72) Inventor: Ryan Guohong Xu, Los Altos, CA (US)

(21) Appl. No.: 15/397,001

(22) Filed: Jan. 3, 2017

(51) Int. Cl. H04L 29/08; H04L 29/12; H04L 12/24; H04L 12/66; H04L 29/06

(52) U.S. Cl. CPC H04L 67/22; H04L 61/1511; H04L 67/02; H04L 69/22; H04L 12/66; H04L 67/306; H04L 41/069

(57) ABSTRACT

Described herein are systems, methods, storage media, and computer programs for tracking user Internet activities in a residential network. In one embodiment, information on a plurality of time sequences of packets that are generated from the user's Internet activities is obtained at a first electronic device. The information on the plurality of time sequences is converted into a plurality of time vector sequences by the first electronic device. Information on a plurality of Internet activities by the user is then derived from the plurality of time vector sequences based on one or more categorization parameters learned from information obtained from a plurality of residential gateways on time sequences of packets, and the information on the plurality of Internet activities is provided to an application of a second electronic device.

### FIELD OF THE INVENTION

The disclosed embodiments relate generally to data processing, including but not exclusively, to track residential internet activities.

### BACKGROUND

Residential data networks are proliferating households worldwide. Through residential data networks, users gain access to the Internet and all the education, entertainment, and services that the Internet offers at home. While residential Internet access offers great convenience, it also presents challenges on how to monitor Internet activities at home. For example, a parent may like to know if a child is playing online video games excessively, a homeowner may want to be notified if a guest uses the Internet improperly, and an owner of an Internet of Thing (IoT) device may want to be alerted if the IoT device is hacked to perform malicious acts. While one may analyze packets generated from a user's Internet activities by examining the destinations of the packets, the destinations are often associated to a content delivery network (CDN) or an unspecified owner, thus the nature of the Internet activities can be disguised. Additionally, much sponsored content accompanies the user's regular Internet activities, and the sponsored content hinders understanding of the user's activities as the user may have no control over the sponsored content. Thus, accurate tracking of users' Internet activities is challenging.

### SUMMARY

Described herein are systems, methods, storage media, and computer programs to track user activities in a residential network.

In one embodiment, a method for tracking residential Internet activities is disclosed. In one embodiment, information on a plurality of time sequences of packets that are generated from the user's Internet activities is obtained at a first electronic device, the information on the plurality of time sequences is stored in a residential gateway of the residential network. The information on the plurality of time sequences is converted into a plurality of time vector sequences by the first electronic device. Information on a plurality of Internet activities by the user is then derived from the plurality of time vector sequences based on one or more categorization parameters learned from information obtained from a plurality of residential gateways on time sequences of packets, and the information on the plurality of Internet activities is provided to an application of a second electronic device.

In one embodiment, an electronic device to track residential Internet activities is disclosed. The electronic device includes a processor and a non-transitory machine readable storage medium that is coupled to the processor, the non-transitory machine readable storage medium containing instructions, which when executed by the processor, cause the electronic device to perform operations. The operations include to obtain information on a plurality of time sequences of packets that are generated from the user's Internet activities, the information on the plurality of time sequences being stored in a residential gateway of the residential network. The operations further include to convert the information on the plurality of time sequences into a plurality of time vector sequences, and derive information on a plurality of Internet activities by the user from the plurality of time vector sequences based on one or more categorization parameters learned from information obtained from a plurality of residential gateways on time sequences of packets. The operations further include to provide the information on the plurality of Internet activities to an application of a second electronic device.

In one embodiment, a non-transitory machine readable storage medium for tracking residential Internet activities is disclosed. The non-transitory machine readable storage medium contains instructions, which when executed by a processor of an electronic device, cause the electronic device to perform operations. The operations include to obtain information on a plurality of time sequences of packets that are generated from the user's Internet activities, the information on the plurality of time sequences being stored in a residential gateway of the residential network. The operations further include to convert the information on the plurality of time sequences into a plurality of time vector sequences, and derive information on a plurality of Internet activities by the user from the plurality of time vector sequences based on one or more categorization parameters learned from information obtained from a plurality of residential gateways on time sequences of packets. The operations further include to provide the information on the plurality of Internet activities to an application of a second electronic device.

Embodiments of the present invention provide ways to efficiently and accurately determine Internet activities of a user in a residential network.

### BRIEF DESCRIPTION OF DRAWINGS

FIG. 1 illustrates a system to track residential Internet activities according one embodiment of the invention.

FIG. 2A illustrates information of packets generated from a user's Internet activities according to one embodiment of the invention.

FIG. 2B illustrates categorization of DNS domain information and data packet information according to one embodiment of the invention.

FIG. 3 illustrates packet sequences according to one embodiments of the invention.

FIG. 4 illustrates a system to analyze time sequences to determine Internet activities of a user according to one embodiment of the invention.

FIG. 5 illustrates one embodiment of a time convolution layer for determining Internet activities of a user according to one embodiment of the invention.

FIG. 6 illustrates learning neural network parameters based on information from multiple residential gateways according to one embodiment of the invention.

FIGS. 7A-C illustrate results of for tracking residential Internet activities according to three embodiments of the invention.

FIG. 8 illustrates a flow diagram for tracking residential Internet activities according to one embodiment of the invention.

FIG. 9 illustrates time convolution of time vector sequences according to one embodiment of the invention.

FIG. 10 is an exemplary illustration of an electronic device according to one embodiment of the invention.

FIG. 11 is an exemplary illustration of an electronic device according to another embodiment of the invention.

### DETAILED DESCRIPTION

The invention is illustrated, by way of example and not by way of limitation, in the figures of the accompanying drawings in which like references indicate similar elements. It should be noted that references to “an” or “one” or “some” embodiment(s) in this disclosure are not necessarily to the same embodiment, and such references mean at least one.

In figures, bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention. Also in the figures, reference numbers are used to refer to various elements or components, the same reference numbers in different figures indicate that the elements or components have the same or similar functionalities.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other. A “set,” as used herein refers to any positive whole number of items including one item.

An electronic device stores and transmits (internally and/or with other electronic devices over a network) code (which is composed of software instructions and which is sometimes referred to as a computer program code or a computer program) and/or data using machine-readable media (also called computer-readable media), such as computer or machine-readable storage media (e.g., magnetic disks, optical disks, read only memory (ROM), flash memory devices, phase change memory) and computer or machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more microprocessors coupled to one or more machine-readable storage media to store code for execution on the set of microprocessors and/or to store data. For instance, an electronic device may include non-volatile memory containing the code because the non-volatile memory can persist code/data even when the electronic device is turned off (when power is removed). When the electronic device is turned on that part of the code that is to be executed by the microprocessor(s) of that electronic device is typically copied from the slower non-volatile memory into volatile memory (e.g., dynamic random-access memory (DRAM), static random-access memory (SRAM)) of that electronic device. Typical electronic devices also include a set or one or more physical network interface(s) to establish network connections (to transmit and/or receive and/or data using propagating signals) with other electronic devices.

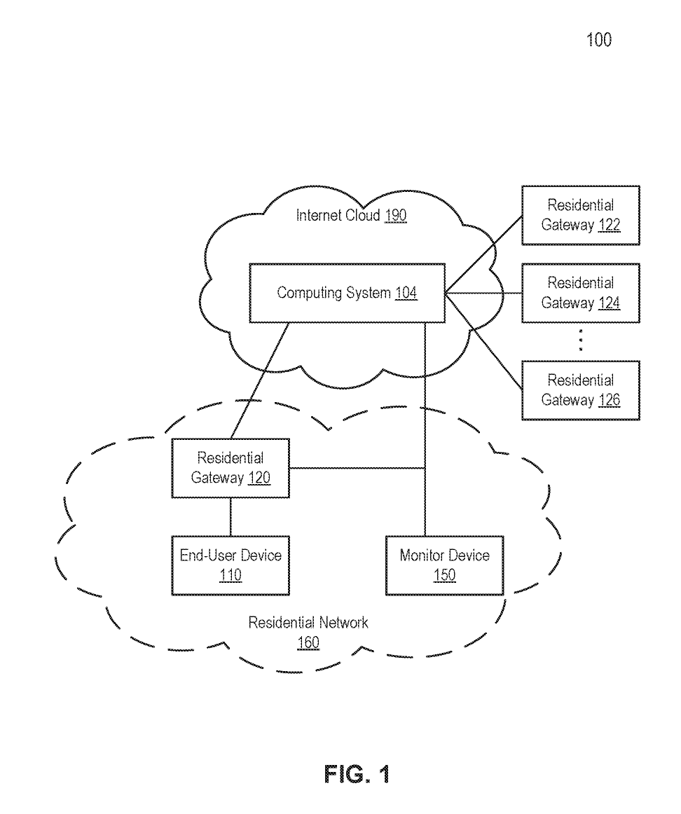

FIG. 1 illustrates a system to track residential Internet activities according one embodiment of the invention. System 100 includes a computing system 104 in the Internet cloud 190, a plurality of residential gateways 120-126, an end-user device 110, and a monitor device 150. Each of the computing system 104, the plurality of residential gateways 120-126, the end-user device 110, and the monitor device 150 is implemented in one or more electronic devices in one embodiment.

An end-user device such as the end-user device 110 interacts with and provides services for a human user. An end-user device may be a workstation, a laptop computer, a netbook, a tablet, an e-book reader, a palm top, a mobile phone, a smartphone, a phablet, a multimedia phone, a Voice Over Internet Protocol (VOIP) phone, a computer desktop/terminal, a portable media player, a GPS unit, a wearable device, a gaming system, a set-top box, a smart speaker (e.g., Amazon® Echo or Google® Home), or an Internet enabled household appliance such as an Internet of Thing (IoT) device.

A residential gateway (RG) such as one of the residential gateways 120-126 interacts with one or more end-user devices and provides Internet access to the one or more end-user devices. A residential gateway is the access point to the Internet cloud 190 for the one or more end-user devices. A residential gateway may be a cable modem, a digital subscriber line (DSL) modem, a wireline or wireless router, a network switch, or a wireless access point. A residential gateway such as the residential gateway 120 interacts with an end-user device such as the end-user device 110 through a variety of media such as one or more of a radio frequency channel (e.g., one used for WiFi or Bluetooth), an optical fiber, a copper line, a power line, or another other suitable medium for communication (e.g., fluid, gas, or solid molecule vibration or motion).

A computing system such as computing system 104 may be a server device provided by a service provider or a cloud provider. The computing system 104 may be placed in a data center of the service provider or the cloud provider. The computing system 104 communicates with multiple residential gateways such as the residential gateways 120-126. Additionally, the computing system 104 communicates with the monitor device 150.

The monitor device 150 monitors Internet activities of one or more end-user devices such as the end-user device 110. The monitor device 150 interacts with the computing system 104 and/or the residential gateway 120 in one embodiment. The monitor device 150 may be a workstation, a laptop computer, a netbook, a tablet, an e-book reader, a palm top, a mobile phone, a smartphone, a phablet, a multimedia phone, a Voice Over Internet Protocol (VOIP) phone, a computer desktop/terminal, a portable media player, a GPS unit, a wearable device, a gaming system. The monitor device 150 may include an application (often referred to as an “App”) or another type of executable program code (e.g., an .exe file) for monitoring the one or more end-user devices. The application or the other type of executable program code may include one or more application programming interfaces (APIs) to interact with an operator of the monitor device 150 and other electronic devices such as the computing system 104 and/or the residential gateway 120. For simplicity of illustration, the discussion below focuses on an application in a monitor device for monitoring Internet activities, but another type of executable program in a monitor device may monitor Internet activities in some embodiments of the invention.

It is to be noted that the communications between the computing system 104 and the residential gateways 120-126, between the computing system 104 and the monitor device 150, and between the residential gateway 120 and the monitor device 150 may be through one or more media that is same as or different from the one for the communications between the residential gateway 120 and the end-user device 110.

The residential gateway 120, the end-user device 110, and the monitor device 150 may be within a residential network 160. The end-user device 110 gains Internet access through the residential gateway 120. The monitor device 150 may be within the residential network 160 and it may also be outside of the residential network 160. For example, the monitor device 150 may be a smartphone belonging to a parent in a household, at which the residential network 160 is located. The parent may bring the smartphone to office, which may have a different local area network (LAN). The parent may monitor Internet activities of the end-user device 110 remotely through the monitor device 150 (e.g., based on information that the residential gateway 120 has provided to the computing system 104, with which the monitor device 150 communicates), even though the monitor device 150 is physically outside of the residential network 160.

The monitor device 150 tracks Internet activities of the end-user device 110. The operator of the monitor device 150 may be a parent while the operator of the end-user device 110 is a child of the parent; the operator of the monitor device 150 may be a homeowner while the operator of the end-user device 110 is a guest of the homeowner; the operator of the monitor device 150 may be an owner of an Internet of Thing (IoT) device, and the end-user device 110 is the IoT device itself. There are many other scenarios that an operator of the monitor device 150 may want to monitor Internet activities of the end-user device 110 in a residential network 160, and embodiments of the invention are not limited to a particular purpose of the monitoring.

For simplicity of illustration, the discussion below focuses on the scenario where the operator of the monitor device 150 (the operator also being referred to as a supervisor herein below) is a parent and the operator of the end-user device is a child of the parent. In that case, the end-user (or simply referred to as a user herein below) is the child. The parent may want to understand the child's Internet activities for providing parental guidance. For example, the parent would like to know information such as the following: (1) how much time the child plays online video games and what kind of video games (e.g., LoL, Minecraft, World of Warcraft, etc.) that the child plays; (2) how often the child stays on social networking applications and what kind of social networking applications (e.g., Snapchat, Tumblr, Instagram, etc.) the child is on; (3) what time the child gets on the Internet and for how long, and/or (4) what is the child doing online at the particular moment in time when the parent open an application of the monitor device 150. In other words, the parent may be interested in tracking the historical and real-time Internet activities of the child.

It is intuitive for the monitor device 150 to obtain a user's Internet activity information from the residential gateway 120. Since the user operates on the end-user device 110, which gains Internet access through the residential gateway 120, the residential gateway 120 may store the packets generated from the user's Internet activities. The monitor device 150 may analyze the generated packets. For example, the monitor device 150 may determine the Domain Name System (DNS) queries and responses generated based on the user's Internet activities. A DNS query for the user may be for leagueoflegends.com, and if the DNS response indicates the IP address of a server for leagueoflegends.com, and a bulk of packets have the destination IP address of the server, then the monitor device 150 may determine with high confidence that the user is playing the game League of Legends (LoL).

However, experiments reveal the flaws of this first approach. An online game or a social networking application often uses content delivery networks (CDNs) extensively to facilitate content delivery, and the content of the online game or the social networking application often comes from a CDN. Thus, the original content provider is masked in an DNS response, which would identify only a CDN server. Thus, the monitor device 150 may not be able to identify the original content provider. Additionally, an online game or a social networking application often has sponsored content (e.g., advertisement from a third party), and the user has no control over what sponsored content is delivered to the end-user device. The user may have no interaction with the sponsored content, but packets of the sponsored content are generated and the IP addresses of the sponsored content may be identified by the monitor device 150. Yet the operator of the monitor device 150, the parent, would have no interest to know the sponsored content when the user, the child of the parent, does not consume the content. Thus, analyzing DNS information and packet IP addresses by themselves are insufficient to track a user's Internet activities.

A second approach is to analyze content of the data packets generated from the user's Internet activities. For example, the payloads of the packets generated from the user's Internet activities may be examined, and the content may be reconstructed from the payloads. Based on the reconstruction, one may find the content to be a video stream from an online game. Yet to understand the content, the analysis needs to be able to understand numerous protocol types in which the payload may be implemented. Additionally, sometimes the packet content is encrypted, so the analysis needs to be able to reverse-engineer the encryption. Thus, reconstruction of the content can be prohibitively expensive. Additionally, reconstruction of the content from the user's Internet activities without the user's consent may violate the user's right to privacy. For example, when a parent confronts the content reconstructed from a child's Internet activities, the child may be resentful to the parent, who would rather use the Internet activity tracking to foster understanding between the parties. Thus, analyzing the content of the packets generated from a user's Internet activities may be undesirable due to its cost and/or privacy concerns.

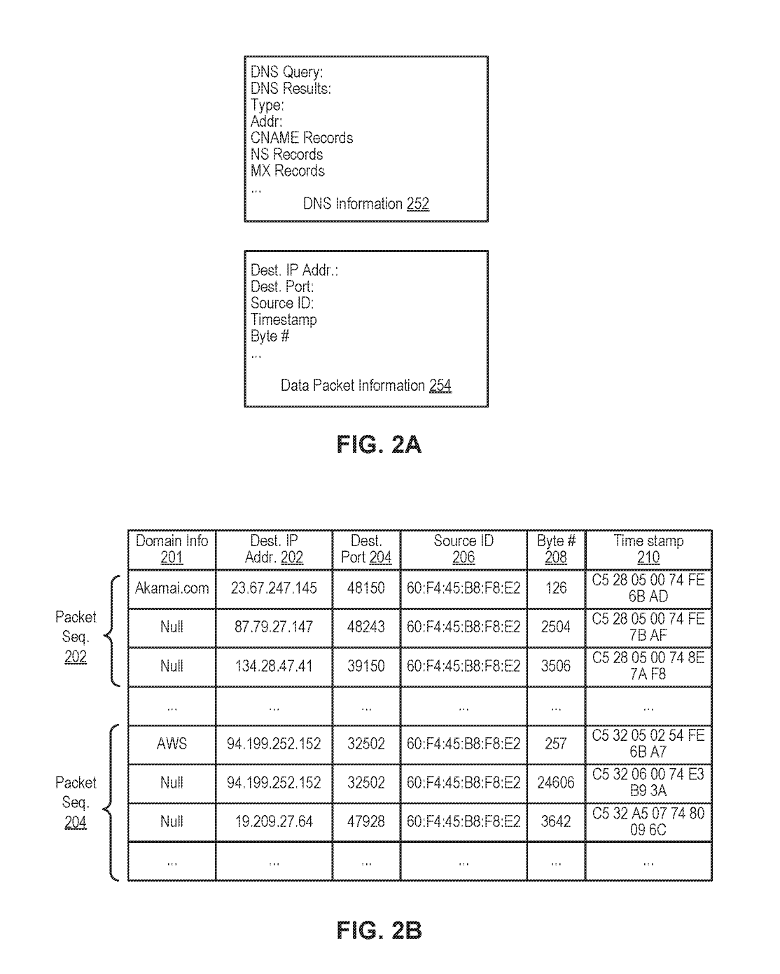

Instead of either approach above, embodiments of the invention exploit information on time sequences of packets generated from a user's Internet activities and determine the user's Internet activities. While the analysis in this case uses more information from the packets than the first approach, it does not examine the content of the packets thus is less expensive than the second approach and get around the privacy concerns. FIG. 2A illustrates information of packets generated from a user's Internet activities according to one embodiment of the invention. The information includes two types, one is Domain Name System (DNS) information such as DNS information 252 and the other is data packet information such as data packet information 254.

The DNS information 252 may be derived from one or more of DNS queries and DNS responses, where the queries and responses are generated in response to the user's Internet activities. For example, the DNS information 252 includes the DNS query, which is a packet generated responsive to the user searches an application. For example, the user typing in “leagueoflegends.com” as a uniform resource locator (URL) or searching for “League of Legends' in a search engine interface, and a DNS query packet is generated to search the IP address of “leagueoflegends.com”. The DNS query results in a DNS response packet, which includes DNS results. As illustrated, the DNS results may include the type of the DNS results (e.g., “A record” pointing to an IP address), one or more IP addresses resulted for the query (e.g., IPv4/v6 addresses), canonical name (CNAME) records, name server (NS) records, and mail exchange (MX) records.

The data packet information 254 may be derived from the data packets generated from the user's Internet activities. The data packet information 254 of a packet may include a destination IP address and a destination port of the packet. The data packet information 254 may also include the source identifier of the packet. The source identifier (ID) may be a source IP address of the packet. In one embodiment, a residential gateway such as the residential gateway 120 provides only a private IP address to an end-user device such as the end-user device 110, and the source ID may include both the private IP address and a source IP port information to uniquely identify the end-user device. In an alternative embodiment, the source ID may be a media access control (MAC) address of the end-user device. The source ID may be another type of information to uniquely identify the end-user device and/or the end-user.

The data packet information 254 may also include a time stamp of the packet. The time stamp establishes the time of the packet (e.g., the time the packet is generated, arrived at the residential gateway, and/or departed the end-user device), thus comparing the time stamps between packets establishes the timing relationship with other data packets generated by the same or different end-user devices. The data packet information 254 may additionally include information of the length of the packet, the packet length information may be the total length of the packet or the length of the payload of the packet.

The DNS information 252 and data packet information 254 may be derived by and stored in a residential gateway from which the end-user device gains Internet access. The residential gateway may collect and/or categorize the information in one embodiment. In another embodiment, the residential gateway may transmit the information to a computing system such as the computing system 104 for collection and categorization.

FIG. 2B illustrates categorization of DNS domain information and data packet information according to one embodiment of the invention. The categorization of the DNS domain information and data packet information facilitates tracking of a user's Internet activities. In one embodiment, the categorization identifies packet sequences based on commonality of groups of packets. For example, FIG. 2B illustrates packets being grouped based on source ID 206. The common source ID indicating the packets come from the same source (e.g., the end-user device 110).

A packet sequence may be a series of packets for a period, following a DNS domain query/result. For example, the domain information 201 is derived from the DNS information 252 in one embodiment of the invention. A packet sequence 202 includes packets with domain information such as the DNS inquiries directed to Akamai.com, a URL of a CDN provider, and the source ID being a MAC address of 60:F4:45:B8:F8:E2 (which identifies an iPhone manufactured by Apple Inc.). The length of the packet sequences may be predetermined, e.g., within a period (e.g., a value between 1˜10 minutes) from the determined domain information.

Note that the destination addresses of the packets and the destination ports of the packets in the packet sequence 202 the destination IP address are different between packets. The packet sequence 202 includes packets with different packet lengths at 126, 2504, and 3506 bytes, and time stamps at C5 28 05 00 74 FE 6B AD, C5 28 05 00 74 1th 7B AF, and C5 28 05 00 74 8E 7A F8 respectively. Some packets within the packet sequence 202 do not have domain information associated with them. As discussed herein above, it is not uncommon that some packets generated from a user's Internet activities are not associated with domain information derived from the DNS information.

Another packet sequence 204 includes domain information such as the DNS inquires directed to Amazon web services (AWS), which is another CDN provider. Some packets of the packet sequence 204 share the same destination IP address 94.199.252.152 and the destination port being 32502, but others do not. The packet sequence 204 includes packets with different packet lengths and time stamps as illustrated. Note that both packet sequences 202 and 204 are not associated with a known game/application such as LoL or Snapchat, thus first approach of analyzing domain information (which reveals only that Akamai and AWS are hosting the related application) is insufficient to track the user's Internet activities.

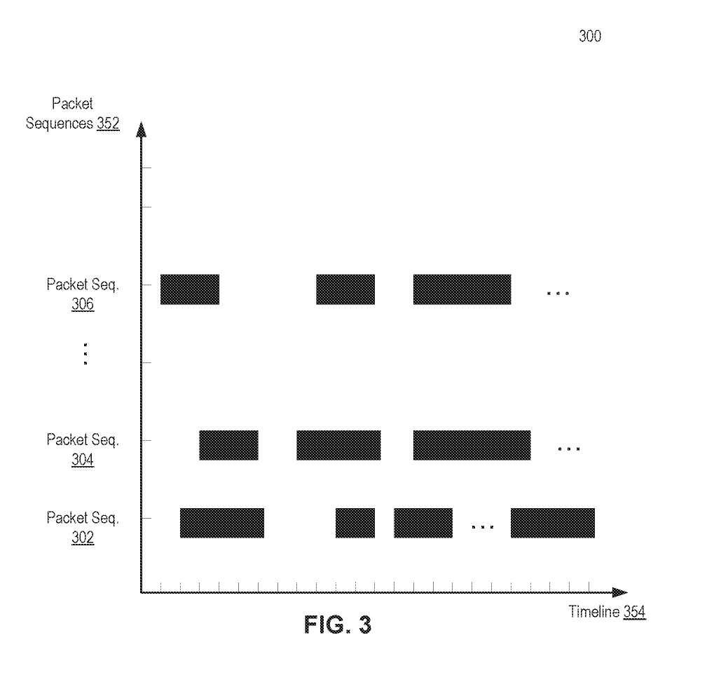

Packet grouping may result in numerous packet sequences similar to the packet sequences 202 and 204. FIG. 3 illustrates packet sequences according to one embodiments of the invention. In FIG. 3, packet sequences 352 are listed along with a timeline 354. Each packet sequence is illustrated in the Cartesian coordinate system 300, based on the time stamps and the lengths of the packets. For example, the starting location of a black block in the x-axis indicates the time stamp of a packet, and the length of the black block indicates a length of the packet. Through the Cartesian coordinate system 300, all or a portion of packet sequences based on a user's Internet activities may be illustrated.

Each packet sequence may be associated with some domain information as illustrated in FIG. 2B. The information derived for each packet sequence may include destination IP addresses, destination ports, the lengths of packets and the time stamps of the packets. For a given packet sequence, one may identify a time sequence of packets, wherein the time sequence includes one or more of destination IP addresses, destination ports, lengths of packets and time stamps of the packets for the given packet sequence in one embodiment.

Categorizing the packets generated from a user's Internet activities through packet sequences without examining the packet payloads enables embodiments of the invention to track the user's Internet activities without significant impact on the user's right to privacy.

The time sequence categorization may be derived from the domain information and data packets generated from a user's Internet activities, but it may exclude the packet payloads of the generated packets, thus the time sequence categorization may greatly reduce the amount of information needed to track the user's Internet activities. With the great reduction by time sequence categorization, embodiments of the invention may use big data concept to analyze users' Internet activities.

Big data concept includes analyzing data generated from a large number of sources (the analysis sometimes referred to as data mining) through techniques such as artificial intelligence (AI), machine learning, and/or visualization. Embodiments of the invention may utilize data generated not only from the residential gateway through which a user gains access, but also from other residential gateways that serve numerous other users to access the Internet. The data generated from the other residential gateways may be used to train a system through which the data generated from the user's residential gateway is analyzed.

For example, another user using another residential gateway may access the same online video game and/or the same social networking application, thus the time sequence of packets generated by the other user may be similar to the time sequence of packets generated by the present user being tracked. By learning information on the time sequence of packets generated by the other user and determine the similarity between the time sequence, the monitor device 150 may determine the online video game and/or the social networking application that the present user is engaged.

With embodiments of the invention, the monitor device 150 may identify that the packets generated from the user's Internet activities are generated from the user's interaction with a plurality of Internet sites that provide the content being consumed by the user. The identification may be based on the time sequences of the packets, where the time sequences contain features similar to features of earlier time sequences resulted from interaction with the plurality of Internet sites. The monitor device 150 matches the user's Internet activities with the plurality of Internet sites from a database of Internet sites (also referred to as target sites) thus tracks the user's Internet activities. Thus, embodiments of the invention include target site recognition from the time sequences of packets generated from the user's Internet activities, e.g., recognizing that the packets are generated from the user's visit of Facebook.com (the target site of the packets).

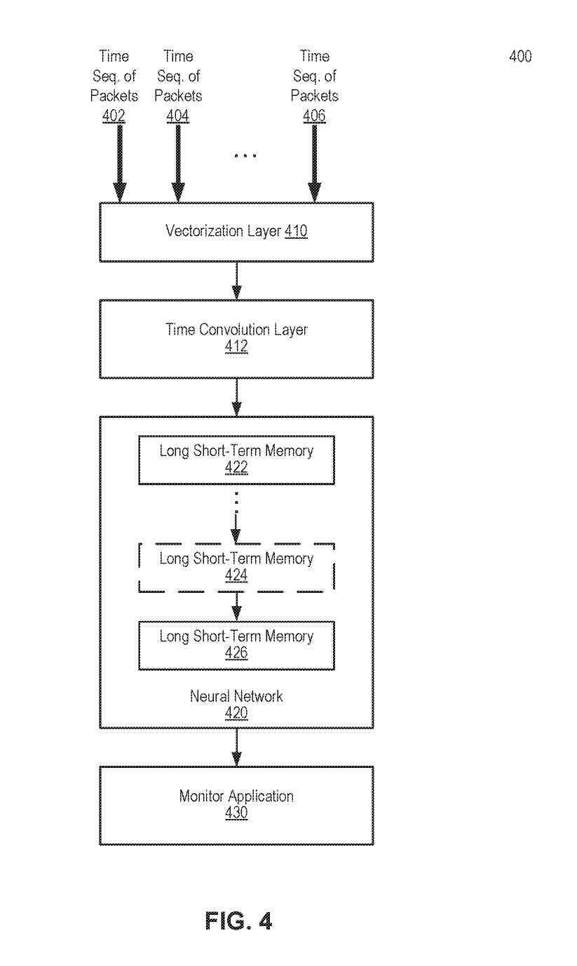

FIG. 4 illustrates a system to analyze time sequences to determine Internet activities of a user according to one embodiment of the invention. System 400 receives information regarding a plurality of time sequences of packets generated from a user's Internet activities, and determines the user's Internet activities. System 400 may be implemented in a computing system in the Internet cloud, such as the computing system 104 in the Internet cloud 190 in one embodiment. In another embodiment, System 400 may be implemented in a residential gateway such as the residential gateway 120.

System 400 includes a vectorization layer 410, a time convolution layer 412, a neural network 420, and a monitor application 430. The vectorization layer 410 converts the information on time sequences of packets such as time sequences of packets 402-406 into time vector sequences. Then the time convolution layer 412 may perform a multi-sequence time convolution on the input of time vector sequences with a filter bank consisting of a plurality of filters. In one embodiment, the time convolution layer 412 align the time vector sequences to the same timeline and remove the impact of difference in starting time of the time sequences. The results may then be sent to a neural network 420 to determine a plurality of Internet activities of the user. The determined Internet activities are then provided to a monitor application 430 of the monitor device 150.

The vectorization layer 410 converts messages/texts into numeric values (e.g., integers) to facilitate further processing in the time convolution layer 412. For example, in the time sequence information, the combination of destination IP address and destination port may be used to identify where a packet is to be forwarded, yet the combination is not a numeric value but a text string, which is hard to measure its closeness to a target value (e.g., how close is the combination of 23.67.247.145+Port 48150 to 94.199.252.152+Port 32502 in target site recognition?). It would make the further processing easier if the text string is converted to one or more numeric values, e.g., a vector. Several ways have been proposed to convert text to vector. Several word processing (e.g., machine learning of language) techniques have used text to vector conversion, for example, N-gram and word2vec (short for word to vector) are used for computational linguistics.

Embodiments of the invention may use the vectorization method to vectorize time sequence information such as the time sequences of packets 402-406. For example, the vectorization of the combination of destination IP address and destination port may be performed to maximize the probability of the resulting destination vector dₜ, given the previously known historical destinations vector, h_{d}. For each time sequence, the objective is to maximize the following:

$${J}_{NEG} = log {Q}_{θ} ( S = 1 \vert {d}_{t} , {h}_{d} ) + k {\sum }_{d ∼ {P}_{noise}} [ log {Q}_{θ} ( S = 0 \vert d , {h}_{d} ) ] \qquad ( 1 )$$

In equation (1), Q_{θ}(S=1|dₜ,h_{d}) is the binary logistic regression probability under which the model seeks the resulting the destination vector dₜ in the context h_{d} in the time sequence S, calculated in terms of the learned embedding vector θ. Embodiments of the invention approximate the expectation by drawing k contrastive destinations from the noise distribution by calculating a Monte Carlo average.

Additionally, the time stamps of a time sequence may be converted to numeric values such as relative time differences, each of which is between packets of the corresponding packet sequence; and byte length is a numeric value already. Thus, after the vectorization layer 410, the time sequences of packets may be converted to vectors each containing a set of numeric values. One time sequence of packets may include a plurality of elements. Each element of the sequence, referred to as a time sequence vector, includes a set of numeric values such as the following: [destination vector dₜ, relative time, byte length]. The vectors of a time sequence of packets may be referred as a time vector sequence of the packets (the packets forming a packet sequence) or simply referred to as a (time) vector sequence of the packets.

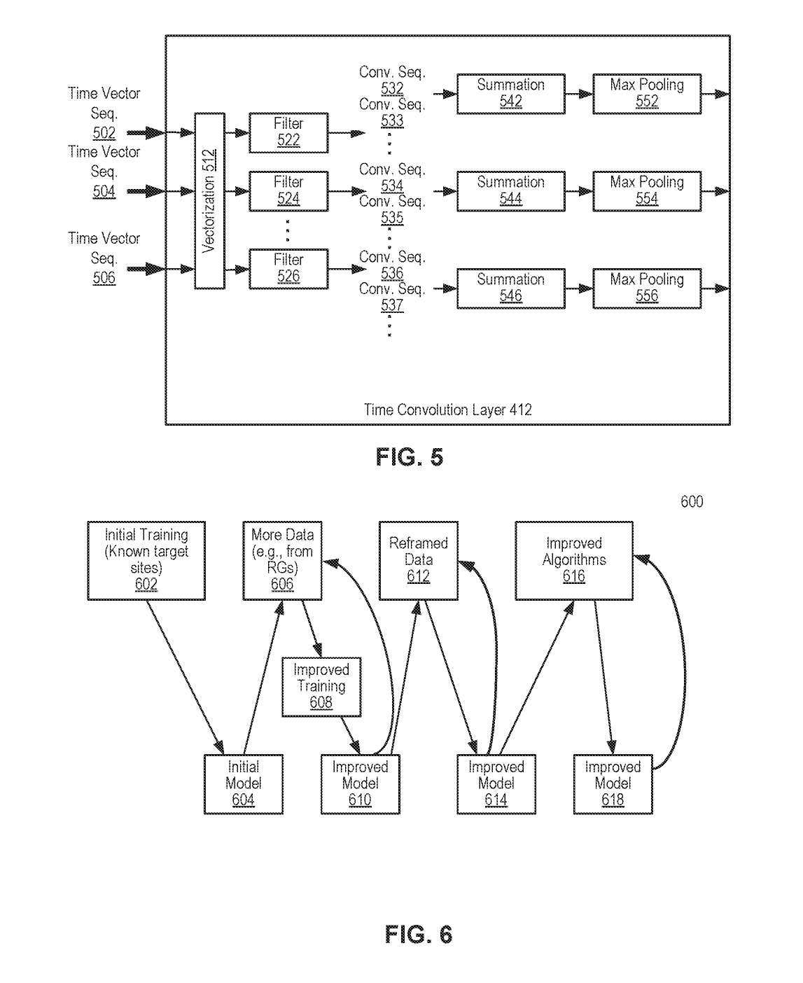

The vector sequence of a packet sequence may be processed by the time convolution layer 412. FIG. 5 illustrates one embodiment of a time convolution layer for determining Internet activities of a user according to one embodiment of the invention. In FIG. 5, vector sequences 502-506 enter to the time convolution layer 412, and outputs convoluted sequences for further processing in a neural network.

The vector sequences are provided to a filter bank, which includes filters 522-526. The vector sequence of a packet sequence may include information illustrated in FIG. 3, and each vector sequence may be viewed as an input to the filter bank.

A vector sequence may be further simplified through a truncation in time, which may be represented by the following:

$$x [ n ] = {\sum }_{i = 0}^{N} {b}_{i} {x}^{′} [ n - i ] \qquad ( 2 )$$

In this equation, an input vector x′[n] is updated to be the new vector sequence, which is truncated into x[n] through the transition, where bᵢ is a weighting constant and N is the length of the FIR filter to process the sequence. The new input vector sequence then goes through a finite impulse response (FIR) filter, which function may be represented by the following:

$$y [ t ] = {\sum }_{s = 0}^{S - 1} {\sum }_{n = 0}^{N - 1} {h}_{s} [ n ] {x}_{s} [ t - n - {τ}_{s} ] \qquad ( 3 )$$

In this equation, hₛ [n] is the n^{th} destination (a combination of IP address and port) of the filter associated with sequence s; xₛ[t] is the number of bytes recorded in the vector sequence s at time t, τ_{c} is the delay between the sequences, and S is the number of vector sequences coupled to the filter bank. The right-hand side of the equation, y[t], is output signal generated by the processing.

In one embodiment, the delay ti in Equation (3) may be determined through a layer of the neural network 420 (discussed in more detail herein below). Similarly, one or more layer of the neural network 420 may determine the FIR filter h[n].

In one embodiment, the time vector sequences from all the time sequences may be used to perform a multiple-sequence time-convolution with a FIR filter bank hₛ={hₛ¹,hₛ², . . . , hₛ^{P}}. Each filter hₛ^{P} is convolved with a specific input vector sequence xₛ and the output for each filter pϵP is summed across all vector sequence s E S. Thus, the multi-sequence time-convolution with the FIR filter bank may be represented by the following:

$${y}^{P} [ t ] = {\sum }_{s = 0}^{S - 1} {\sum }_{n = 0}^{N - 1} {h}_{s}^{P} [ n ] {x}_{s} [ t - n ] \qquad ( 4 )$$

In one embodiment, Equation (4) is used to perform a multi-sequence time-convolution with a time-domain filter bank, such as a Gammatone filter bank, followed by rectification and averaging over a window. It is to be noted that the convolution may be performed on vector sequences from cross-devices (e.g., vector sequences from different residential gateways).

Through the FIR filter bank such as the one containing the filters 522-526, the vector sequences from the multiple time sequences of packets may be transitioned into the convolved sequences 532-537. It is to be noted that each filter may be time-convolved with all the vector sequences. Thus, if there are 10 time sequences and 2 filters (the filter number may be a value in the range of 2-10), each filter will output 10 convolved sequences.

The convolved sequences are then summed through the summation modules such as summations 542-546. The summation is to produce time sequences that have time/phase shift impact removed. Each summation module sums up all the convolved sequences produced by one filter of the filter bank in one embodiment. Thus, the summation 542 sums the output of the filter 522, including the convolved sequences 532-533, the summation 544 sums the output of the filter 524, including the convolved sequences 534-535, and summation 546 sums the output of the filter 526, including the convolved sequences 536-537.

Then each of the outputs of the summations 542 is provided to a max pooling module such as max pooling modules 552-556. Max pooling is a form of non-linear down-sampling. For example, max pooling may partition the outputs of a summation module into a set of non-overlapping regions of convolved time sequences (which are summed up by the summation module). For each region, the maximum value of the vectors is selected for the region. The intuition is that it is more important to know a maximum value exists in a region than to know the exact location of the maxim value in the region. A max pooling module may process through the entire time length of the output of its corresponding summation module. The output of the max pooling modules such as the max pooling modules 552-556 are then provided to the neural network 420.

Referring to FIG. 4, the neural network 420 may include a plurality of long short-term memory (LSTM) layers. The number of LSTM layers depend on implementation and is often in the range of 3˜100 layers. However, embodiments of the invention are not limited to a particular number of LSTM layers. The output of the plurality of the LSTM layer includes identified target sites, each from a time sequence of packets of the input time sequences 402-406. It is to be noted that the neural network 420 may also include one or more deep neural networks in one embodiment.

Each LSTM layer may contain one or more LSTM blocks (also referred to as neurons). Each LSTM block may include several types of gates: an input gate that controls the extent to which a new value flows into the memory of the LSTM layer; a forget gate that controls the extent to which a value remains in memory; and an output gate that controls the extent to which the value in memory is used to compute the output activation of the block.

For each LSTM layer, an activation function defines the output of the LSTM layer given a set of inputs. The activation function of a LSTM layer may be calculated through the following set of functions:

fₜ=σ_{g}(W_{f}*xₜ+U_{f}*hₜ₋₁+V_{f}∘cₜ₋₁+b_{f})

iₜ=σ_{g}(Wᵢ*xₜ+Uᵢ*hₜ₋₁+Vᵢ∘cₜ₋₁+bᵢ)

oₜ=σ_{g}(Wₒ*xₜ+Uₒ*hₜ₋₁+Vₒ∘cₜ₋₁+bₒ)

cₜ=fₜ∘cₜ₋₁+iₜ∘σ_{c}(W_{c}*xₜ+U_{c}*hₜ₋₁+b_{c})

hₜ=oₜ∘σₕ(cₜ) (5)

Within the Equations (5), xₜ is the input destination vector (a numeric expression of a combination of destination IP address and port as discussed herein above), hₜ is the output vector that is to compare to the output targets, cₜ is the cell state vector. W, U, and b are parameter matrices and vector. Additionally, fₜ is the forget gate vector, iₜ is the input gate vector, and o_{f} is the output gate vector; and activation function σ_{g} is a sigmoid function, σ_{c} is a hyperbolic tangent and σₕ is another hyperbolic tangent.

The parameter matrices and vectors W, U, and b may be adjusted based on learning from information on time sequences of packets, where the information on the time sequences may be obtained from a plurality of residential gateways such as the residential gateways 120-126. In other words, the parameters of the neural network 420 may be learned from not only from the residential gateway through which a user gains access, but also from other residential gateways that serve numerous other users to access the Internet.

FIG. 6 illustrates learning neural network parameters based on information from multiple residential gateways according to one embodiment of the invention. The neural network parameters include the parameter matrices and vectors W, U, and b of the plurality of long short-term memory (LSTM) layers discussed herein above, and the state machine 600 may improve the model with the optimized parameter matrices and vectors W, U, and b.

The training to optimize the neural network parameters starts with known target sites at reference 602. For example, one may arrange a user to play an online video game for several hours and collect information (destination IP address, destination port, packet length, and/or timestamps) of the packets generated from the activities. The generated time sequence of packets from the known online video game play is processed through a system such as System 400. The parameters of the neural network along with the parameters for vectorization (see e.g., Equation (1)), and/or time convolution layer parameters (see e.g., Equations (2)-(4)) are optimized to maximize the probability of the result of neural network identification to identify the known online video game as the target site. The user may also be monitored while engaging in other Internet activities, and the generated time sequences of packets from interacting with the other known Internet activities may be used to further optimize the parameters.

The training results an initial mode at reference 604, which includes the parameters of the initial training. The initial training model may be then applied to more data, including information on time sequences of packets generated from a plurality of residential gateways at reference 606. The more data may be used to improve the training and optimizes the parameters of the initial training.

It is to be noted that the time sequences of packets generated from the plurality of residential gateways are matched against known target sites first. If the matching results in a matching probability over a threshold probability for a time sequence with a target site, the match may be considered good enough, and the time sequence becomes a known sequence for the target site. If the matching is lower than a threshold probability for the time sequence with all known sites, the neural network may consider the time sequence is with a new site, and add the new site as a target site in the neural network's target site database. The added new site is added to the improved model, and more data is obtained from the plurality of gateways at reference 606 to get improved training at reference 606. With added data at reference 606, the improved training at 608 results in better modeling at reference 610.

The improved model may also reframe the data at reference 612. At this stage, data are not added but are analyzed differently. For example, while the initially packet sequences are delineated with DNS domain information+2 minutes (capturing packets following DNS domain information packet within 2 minutes of time window), here the same data may be delineated with DNS domain information+4 minutes. If the latter results in a faster convergence and/or more accuracy in identifying the target sites from the data, the reframed data results in a better model at reference 614.

The improved model at reference 614 may be further enhanced by enhancing the algorithms at reference 616. The algorithms may be enhanced by further adjusting the LSTM layers. For example, one may add more LSTM layers may be added to the neural network 420 to see if the changes may result in in a faster convergence and/or more accuracy in identifying the target site from the data, the reframed data results in a better model at reference 618.

It is to be noted that backward propagation is provided in the learning process. For example, as illustrated, the improved models 610, 614, and 618 provide feedback to the earlier stages, indicating whether a faster convergence and/or more accuracy in identification is caused by the additional data provided by operations in references 606, reframed data provided by operations in reference 612, and/or improved algorithms 616 provided by operations in reference 616 respectively.

Not only that the neural network parameters may be learned based on data from the initial training and additional data from the plurality of gateways, but also the parameters for vectorization (see e.g., Equation (1)) and/or time convolution layer parameters (see e.g., Equations (2)-(4)) can be optimized use a same or similar state machine. The multiple layers of the LSTM in the neural network 420 may be involved in optimizing these different types of parameters in System 400. Thus, these different types of parameters may be optimized using different LSTM layers simultaneously. While FIG. 4 illustrates the LSTM layers are within the neural network 420, when the parameters for vectorization and/or time convolution layer parameters are trained using some of the LSTM layers, the involved LSTM layers are within the vectorization layer 410 and/or time convolution layer 412 respectively.

In the analysis of vector sequences through the LSTM layers, the byte amount of a packet sequence may be given undue weight in identifying target sites of a user's Internet activities. While some Internet activities generate significant number of packets of great byte lengths, other Internet activities may generate fewer packets and/or packets with less byte lengths. For example, snapchat, being a text-based social networking application, may generate fewer packets and/or packets with less byte lengths than LoL, even if the user engages with the former for a longer period of time and with more intensity (e.g., snapchat with a large number of individuals). A parent would be equally concerned, if not more so, when his/her child is excessively involved in social networking applications than online video games. Thus, the learning of the different types of parameters need to rank different activates based on their traffic characteristics and prioritize some Internet activities with low byte amount time sequences.

Additionally, as discussed here above, some packets are generated outside of the user's control and the user does not consume the content associated with the packets. For example, advertisement may be inserted to the game the user plays or the social networking application the user is used, and those advertisement is of little interest to a parent monitor a child's Internet activities, thus the neural network 420 may filter out some Internet activities.

Referring to FIG. 4, the neural network 420 identifies target sites for the input time sequences 402-406 through a state machine such as the state machine 600. In one embodiment, the operations in the vectorization layer 410, the time convolution layer 412, and the neural network 420 may be performed without the source ID information being further processed. Thus, the learning of these different types of parameters may be performed without knowing the end-user. The advantage of such embodiment is that the privacy of the end-user is protected. It is important when information of time sequences of packets is obtained from a plurality of residential gateways. The users of the other residential gateways may not want to reveal personal identity information such as the source IDs, thus learning without the source ID information may be advantageous. After the target sites are identified, the source ID information then may be added to the information provided to the monitor application 430 which can present the information with the source ID identifying the user, whose Internet activities are being tracked.

The monitor application 430 may contain one or more APIs to further process the information from the neural network 420 and/or display the identified target sites and related information to the operator of the monitor device (supervisor).

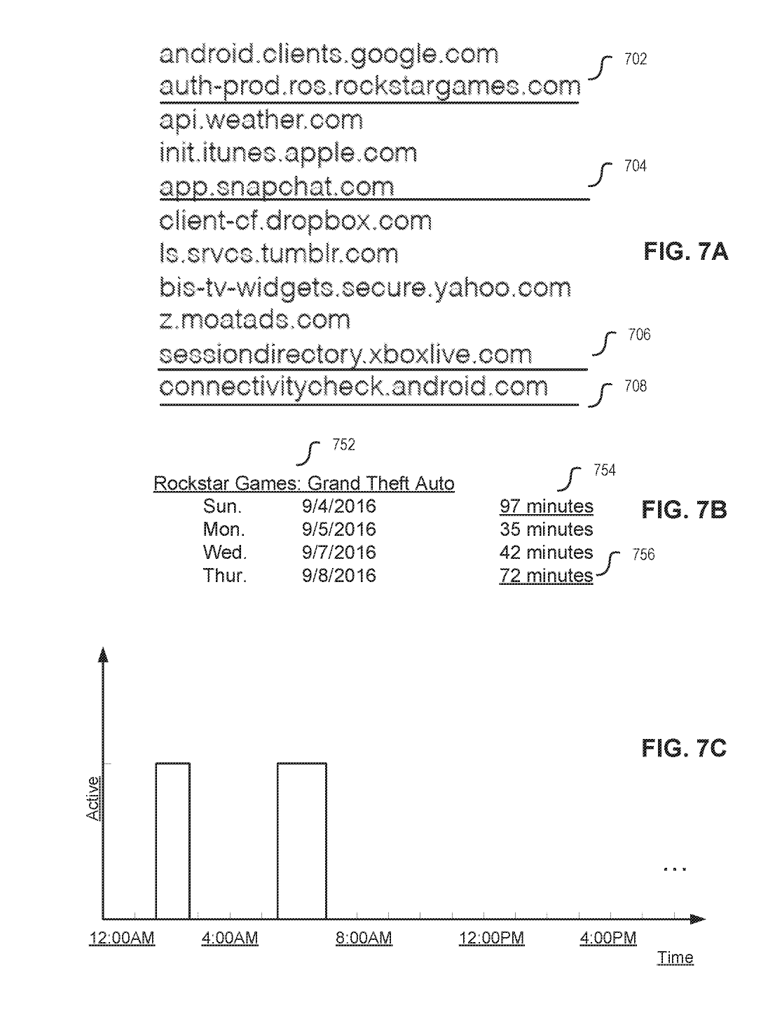

FIG. 7A illustrates a result of for tracking residential Internet activities according to a first embodiment of the invention. The input time sequences 402-406 results in a list of websites and applications that the user has interacted with. For example, the user appears to have played the game Rock Star based on reference 702, and he/she have used Snapchat based on reference 704. Note that the snapchat is ranked higher than Xbox live (reference 706), even though the latter may generate more packets and/or longer packets. As discussed herein above, the neural network 420 may prioritize some Internet activities over others based on the Internet activity′ traffic characteristics.

It is to be noted that connectivity check of Android is ranked last at reference 708. Likely the user may not be actively engaged with this website connectivitycheck.android.com, and this target site is likely of little interest to a parent to monitor a child's Internet activity, thus this target site may be filtered out prior to providing to the monitor application 430. On the other hand, in some application, such target site is of interest. For example, if the monitored end-user device is an IoT device, the monitor application 430 may want to be alerted when the IoT device is making a connectivity check, which may be a precursor of a hacker trying to redirect the IoT device to a malicious act. In that application, target site such as the one at reference 708 may be prioritized to the top of the activity list.

FIG. 7B illustrates a result of for tracking residential Internet activities according to a second embodiment of the invention. FIG. 7A provides a list of Internet activities of the user. Often the list by itself is insufficient. The supervisor of the monitor device, e.g., a parent, may select one activity and learn more details of the activity. For example, when the parent selects auth-prod.ros.rockstargames.com, the name of the activity is displayed. In this example, the activity is the game of Grand Theft Auto by Rockstar Games as illustrated at reference 752.

The parent may select the name of the activity (e.g., by clicking “Rockstar Games: Grand Theft Auto”), and the monitor application 430 may provide a brief introduction about the game “Grand Theft Auto”. For example, the monitor application 430 may direct the parent to the Wikipedia page of the game. With the information, the parent may understand the interest of the child.

Following the name of the activity, the details of the activity may be displayed. In this example, the user has played four days in the week so far. The supervisor, the parent, may be fine with the child plays a longer period of time over the weekend (e.g., 97 minutes on a Sunday at reference 754), he/she may be more concerned about activity over the weekdays such as 72 minutes on Thursday at reference 756. The parent may select the 72 minutes to view more details.

FIG. 7C illustrates a result of for tracking residential Internet activities according to a third embodiment of the invention. FIG. 7C provides a histogram of a particular Internet activity. In this example, when the parent selects the 72 minutes at reference 756, the parent may be presented the detailed activity log of the particular Internet activity (i.e., playing Grand Theft Auto online video game). The user appears to be on the Internet activity after midnight and prior to school hours, and it may be of great concern to the parent.

It is to be noted that the results for tracking residential Internet activities illustrated in FIGS. 7A-C are for illustration only, and embodiments of the invention may some or all the illustrated presentation; alternatively, other presentations may also present a user's Internet activities based on the results from the neural network 420.

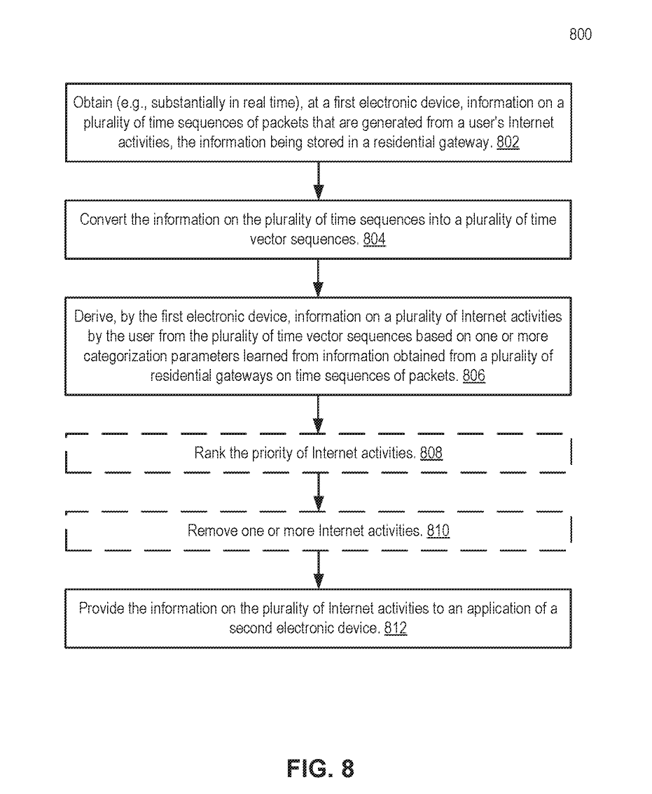

FIG. 8 illustrates a flow diagram for tracking residential Internet activities according to one embodiment of the invention. Method 800 may be implemented in a computing system such as the computing system 104 or a residential gateway such as the residential gateway 120.

At reference 802, information on a plurality of time sequences of packets is obtained. The plurality of time sequences are generated from a user's Internet activities. The information is stored in a residential gateway of the residential network prior to be obtained for tracking residential Internet activities. When the method 800 is implemented in the computing system 104, the information is transmitted to the computing system 104, and when method 800 is implemented in the residential gateway 120, the information is obtained locally.

In one embodiment, the information on the plurality of time sequences of packets that are generated from the user's Internet activities is obtained substantially in real-time. For example, the information is regarding packets that are generated from the user's Internet activities within several minutes (e.g., a value between 1˜10 minutes) of the obtainment. The objective of the substantial real-time obtainment includes tracking in real-time or near real-time the user's Internet activities. It can be useful in some scenarios, e.g., a parent may want to know a child's Internet at the moment in time. The real-time or near real-time tracking may use less packet information thus may be performed quickly.

In one embodiment, the information on the plurality of time sequences of packets includes, for a packet, a destination IP address, a destination port number, a byte number of the packet, a user identifier, and a time stamp. The user identifier may identify an end-user device involved in the user's Internet activities. The user identifier is the source ID discussed herein above in one embodiment. In one embodiment, the information on the plurality of time sequences of packets includes, for the packet, at least one of a Domain Name System (DNS) query and a DNS result that corresponds to the destination IP address.

At reference 804, the information on the plurality of time sequences is converted into a plurality of time vector sequences by the first electronic device. Each time sequence is converted into one time vector sequence in one embodiment. In one embodiment, converting the information on the plurality of time sequences into a plurality of time vector sequences includes converting, for the packet, a combination of the destination IP address and the destination port number into a numeric value (e.g., an integer). Additionally, the time stamp information and the byte length information are included in the time vector sequences as discussed herein above.

At reference 806, information on a plurality of Internet activities by the user is derived from the plurality of time vector sequences based on one or more categorization parameters learned from information obtained from a plurality of residential gateways on time sequences of packets. The plurality of residential gateways serve multiple other users whose Internet activities generate packets. The information on time sequences of those packets may use to train the vectorization layer 410, the time convolution layer 412, and the neural network 420. For example, as discussed herein above and expressed in Equations (1)-(5), the parameters used in these layers may be trained using the information on the time sequences of those packets.

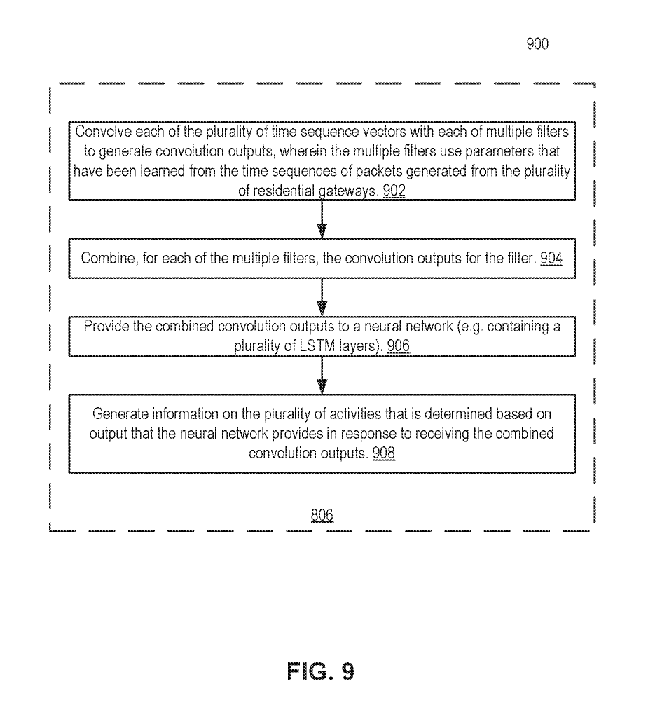

In one embodiment, the derivation of the information on the plurality of Internet activities by the users includes time convolution of the plurality of time vector sequences. FIG. 9 illustrates time convolution of time vector sequences according to one embodiment of the invention. The operations of method 900 is one embodiment of reference 806.

At reference 902, each of the plurality of time vector sequences is convolved with each of multiple filters to generate convolution outputs. The multiple filters use parameters that have been learned from the information on time sequences of packets obtained from the plurality of residential gateways. Then at reference 904, for each of the multiple filters, the convolution outputs for the filter is combined. At reference 906, the combined convolution outputs are provided to a neural network. At reference 908, the information on the plurality of activities is generated, the information is determined based on output that the neural network provides in response to receiving the combined convolution outputs.

As discussed herein above, the neural network may comprise a plurality of long-short term memory (LSTM) layers in one embodiment of the invention. In one embodiment, parameters of the plurality of LSTM layers are learned from the time sequences of packets obtained from the plurality of residential gateways.

Referring to FIG. 8, in one embodiment, the plurality of Internet activities are ranked based on traffic characteristics at reference 808. The ranking may prioritize some Internet activities that have low byte amount. In one embodiment, one or more Internet activities is removed from the plurality of Internet activities at reference 810, prior to providing the information on the plurality of Internet activities to the application. The removal may be due to the one or more Internet activities are deemed not to be of interest to the tracking (e.g., the operator of the monitor device is not interested to learn advertisement the user does not interact with).

At reference 812, the information on the plurality of Internet activities is provided to an application of a second electronic device. The information on the plurality of Internet activities may be provided through one or more APIs on the second electronic device such as the monitor device 150. As discussed herein above in relation to FIGS. 7A-C, many different presentations may be provided to an operator of the second electronic device.

In one embodiment, information on one Internet activity to the application of the second electronic device includes a uniform resource locator (URL). In one embodiment, information on one Internet activity to the application of the second electronic device includes a time log of the user engaging in the Internet activity.

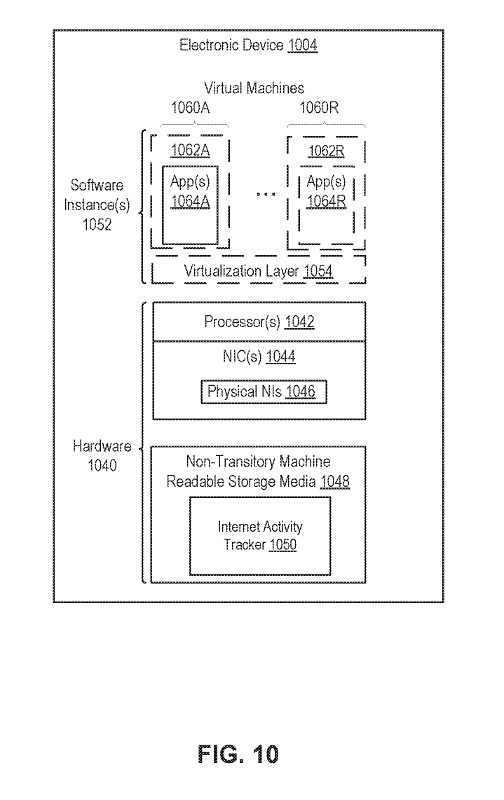

FIG. 10 is an exemplary illustration of an electronic device according to one embodiment of the invention. An electronic device 1004 includes hardware 1040 comprising a set of one or more processor(s) 1042 (which are often commercial off-the-shelf (COTS) processors) and network interface controller(s) 1044 (NICs, also known as network interface cards) (which include physical NIs 1046), as well as non-transitory machine readable storage media 1048 having stored therein an Internet activity tracker 1050. The Internet activity tracker 1050 performs operations discussed herein above relating to FIGS. 8-9.

During operation, the processor(s) 1042 execute the Internet activity tracker 1050 to instantiate one or more sets of one or more applications 1064A-R. While one embodiment does not implement virtualization, alternative embodiments may use different forms of virtualization. For example, in one such alternative embodiment the virtualization layer 1054 represents the kernel of an operating system (or a shim executing on a base operating system) that allows for the creation of multiple instances 1062A-R called software containers that may each be used to execute one (or more) of the sets of applications 1064A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes.

In another such alternative embodiment the virtualization layer 1054 represents a hypervisor (sometimes referred to as a virtual machine monitor (VMM)) or a hypervisor executing on top of a host operating system, and each of the sets of applications 1064A-R is run on top of a guest operating system within an instance 1062A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1040, directly on a hypervisor (in which case the unikernel is sometimes described as running within a LibOS virtual machine), or in a software container, embodiments can be implemented fully with unikernels running directly on a hypervisor represented by virtualization layer 1054, unikernels running within software containers represented by instances 1062A-R, or as a combination of unikernels and the above-described techniques (e.g., unikernels and virtual machines both run directly on a hypervisor, unikernels and sets of applications that are run in different software containers).

The instantiation of the one or more sets of one or more applications 1064A-R, as well as virtualization if implemented, are collectively referred to as software instance(s) 1052.

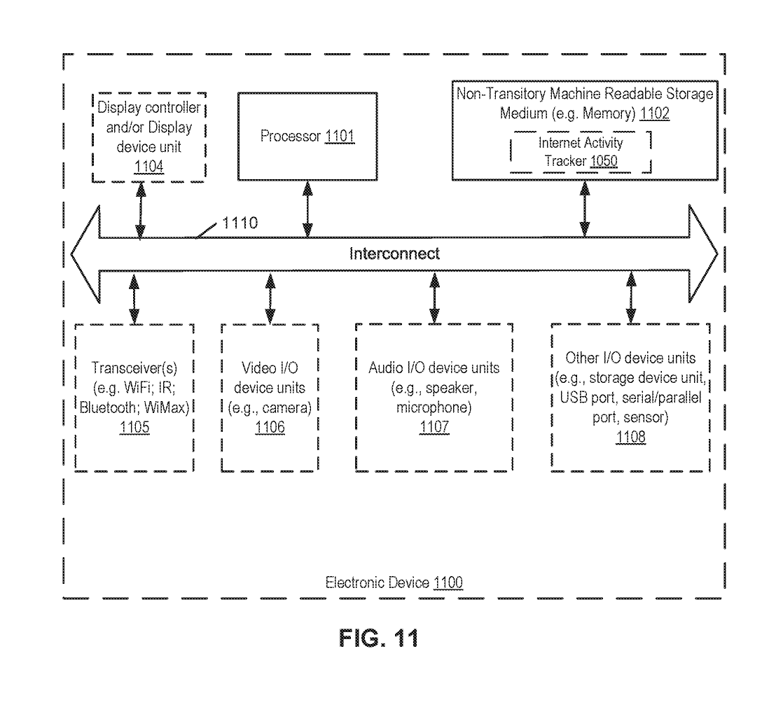

FIG. 11 is an exemplary illustration of an electronic device according to another embodiment of the invention. The electronic device 1100 may perform similar functions as the computing system 104 or the monitor device 150, and it includes many different components. These components can be implemented as integrated circuits (ICs), portions thereof, discrete electronic devices, or other modules adapted to a circuit board such as a motherboard or add-in card of a computing system, or as components otherwise incorporated within a chassis of the computing system. Note also that the electronic device 1100 is intended to show a high-level view of many components of the computing system. However, it is to be understood that additional components may be present in certain implementations and furthermore, different arrangements of the components shown may occur in other implementations. In one embodiment, the electronic device 1100 comprises a processor 1101 and non-transitory machine-readable storage medium 1102 that is coupled to the processor 1101. The non-transitory machine-readable storage medium 1102 includes the Internet activity tracker 1050 discussed herein above in one embodiment, and in that embodiment, the electronic device 1100 performs the functionalities of the computing system 104.

In one embodiment, in addition to the processor 1101 and non-transitory machine-readable storage medium 1102, the electronic device 1100 optional devices 1104-1108 that are interconnected via a bus or an interconnect 1110. The processor 1101 represents one or more general-purpose processors such as a central processing unit (CPU), or processing device. More particularly, the processor 1101 may be a complex instruction set computing (CISC) microprocessor, reduced instruction set computing (RISC) microprocessor, very long instruction word (VLIW) microprocessor, or microprocessor implementing other instruction sets, or microprocessors implementing a combination of instruction sets. The processor 1101 may be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

The processor 1101 may communicate with the non-transitory machine-readable storage medium 1102 (also called computer-readable storage medium), such as magnetic disks, optical disks, read only memory (ROM), flash memory devices, and phase change memory. The non-transitory machine-readable storage medium 1102 may store information including sequences of instructions, such as computer programs, that are executed by the processor 1101, or any other device units. For example, executable code and/or data of a variety of operating systems, device drivers, firmware (e.g., input output basic system or basic input/output system (BIOS)), and/or applications can be loaded in the processor 1101 and executed by the processor 1101.

The non-transitory machine-readable storage medium 1102 contains instructions, which when executed by a processor such as the processor 1101, cause the electronic device 1100 to perform operations as discussed herein above relating to FIGS. 8-9 in one embodiment.

The electronic device 1100 may optionally further include display control and/or display device unit 1104, transceiver(s) 1105, video input/output (I/O) device unit(s) 1106, audio I/O device unit(s) 1107, and other I/O device units 1108 as illustrated. The transceiver 1105 may be a wireline transceiver or a wireless one such as a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof.

The video I/O device unit 1106 may include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips and conferencing. The video I/O device unit 1106 may be a camera/camcorder (e.g., standard definition (SD) or high definition (HD) such as 4K, 8K or higher) in one embodiment.

An audio I/O device unit 1107 may include a speaker and/or a microphone to facilitate voice-enabled functions, such as voice recognition, voice replication, digital recording, and/or telephony functions. Other optional I/O devices 1108 may include a storage device (e.g., a hard drive, a flash memory device), universal serial bus (USB) port(s), parallel port(s), serial port(s), a printer, a network interface, a bus bridge (e.g., a PCI (peripheral component interconnect)—PCI bridge), sensor(s) (e.g., one or more of a positioning sensor, a motion sensor such as an accelerometer, an inertial sensor, an image sensor, a gyroscope, a magnetometer, a light sensor, a compass, a proximity sensor, a thermal sensor, an altitude sensor, and an ambient light sensor), or a combination thereof. The positioning sensor may be for a positioning system such as global positioning system (GPS), global navigation satellite system (GLONASS), Galileo, Beidou, or GPS aided Geo Augmented Navigation (GAGAN). The other optional I/O devices 1108 may further include certain sensors coupled to the interconnect 1110 via a sensor hub (not shown), while other devices such as a thermal sensor, an altitude sensor, an accelerometer, and an ambient light sensor may be controlled by an embedded controller (not shown), dependent upon the specific configuration or design of the electronic device 1100.

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the invention.

The foregoing description of the present invention has been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A method for identifying Internet activities of a user in a residential network, comprising:
obtaining, at a first electronic device, information on a plurality of time sequences of packets that are generated from the user's Internet activities, the information on the plurality of time sequences being stored in a residential gateway of the residential network;
converting, by the first electronic device, the information on the plurality of time sequences into a plurality of time vector sequences;
deriving, by the first electronic device, information on a plurality of Internet activities by the user from the plurality of time vector sequences based on one or more categorization parameters learned from information obtained from a plurality of residential gateways on time sequences of packets; and
providing the information on the plurality of Internet activities to an application of a second electronic device.

2. The method of claim 1, wherein the information on the plurality of time sequences of packets that are generated from the user's Internet activities is obtained substantially in real-time.

3. The method of claim 1, wherein the information on the plurality of time sequences of packets includes, for a packet, a destination IP address, a destination port number, a byte number of the packet, a user identifier, and a time stamp.

4. The method of claim 3, wherein the information on the plurality of time sequences of packets includes, for the packet, at least one of a Domain Name System (DNS) query and a DNS result that corresponds to the destination IP address.

5. The method of claim 3, wherein converting the information on the plurality of time sequences into a plurality of time vector sequences includes converting, for the packet, a combination of the destination IP address and the destination port number into a numeric value.

6. The method of claim 1, wherein the deriving further comprises:
ranking the plurality of Internet activities prior to providing the information on the plurality of Internet activities to the application.

7. The method of claim 1, wherein the deriving further comprises:
removing one or more Internet activities from the plurality of Internet activities prior to providing the information on remaining Internet activities to the application.

8. The method of claim 1, wherein deriving the information on the plurality of Internet activities by the user comprises:
convolving each of the plurality of time vector sequences with each of multiple filters to generate convolution outputs, wherein the multiple filters use parameters that have been learned from the information on time sequences of packets obtained from the plurality of residential gateways;
combining, for each of the multiple filters, the convolution outputs for the filter;
providing the combined convolution outputs to a neural network; and
generating the information on the plurality of Internet activities determined based on output that the neural network provides in response to receiving the combined convolution outputs.

9. The method of claim 8, wherein the neural network comprises a plurality of long-short term memory (LSTM) layers.

10. The method of claim 9, wherein parameters of the plurality of LSTM layers are learned from the time sequences of packets obtained from the plurality of residential gateways.

11. The method of claim 1, wherein information on one Internet activity to the application of the second electronic device includes a uniform resource locator (URL).

12. The method of claim 1, wherein information on one Internet activity to the application of the second electronic device includes a time log of the user engaging in the Internet activity.

13. An electronic device to track residential Internet activities of a user in a residential network, comprising:
a processor and a non-transitory machine readable storage medium that is coupled to the processor, the non-transitory machine readable storage medium containing instructions, which when executed by the processor, cause the electronic device to:
obtain information on a plurality of time sequences of packets that are generated from the user's Internet activities, the information on the plurality of time sequences being stored in a residential gateway of the residential network,
convert the information on the plurality of time sequences into a plurality of time vector sequences,
derive information on a plurality of Internet activities by the user from the plurality of time vector sequences based on one or more categorization parameters learned from information obtained from a plurality of residential gateways on time sequences of packets, and
provide the information on the plurality of Internet activities to an application of another electronic device.

14. The electronic device of claim 13, wherein the information on the plurality of time sequences of packets includes, for a packet, a destination IP address, a destination port number, a byte number of the packet, a user identifier, and a time stamp.

15. The electronic device of claim 14, wherein the information on the plurality of time sequences of packets includes, for the packet, at least one of a Domain Name System (DNS) query and a DNS result that corresponds to the destination IP address.

16. The electronic device of claim 13, wherein derivation of the information on the plurality of Internet activities by the user is to:
convolve each of the plurality of time vector sequences with each of multiple filters to generate convolution outputs, wherein the multiple filters use parameters that have been learned from the information on time sequences of packets obtained from the plurality of residential gateways,
combine, for each of the multiple filters, the convolution outputs for the filter,
provide the combined convolution outputs to a neural network; and
generate the information on the plurality of Internet activities determined based on output that the neural network provides in response to receiving the combined convolution outputs.

17. The electronic device of claim 16, wherein the neural network comprises a plurality of long-short term memory (LSTM) layers.

18. The electronic device of claim 17, wherein parameters of the plurality of LSTM layers are learned from the time sequences of packets obtained from the plurality of residential gateways.

19. The electronic device of claim 13, wherein information on one Internet activity to the application of the another electronic device includes a uniform resource locator (URL).

20. The electronic device of claim 13, wherein information on one Internet activity to the application of the another electronic device includes a time log of the user engaging in the Internet activity.
